(19) United States
(12) Patent Application Publication
(10) Pub. No.: US 2017/0178201 A1
(43) Pub. Date: Jun. 22, 2017

(54) FORMATTING ADVERTISEMENTS

(71) Applicants: Tomasz J. Tunguz-Zawislak, San Francisco, CA (US); Nathan Lucash, San Francisco, CA (US); Sandra Tsui, San Francisco, CA (US); Leslie Chiang, Santa Clara, CA (US)

(72) Inventors: Tomasz J. Tunguz-Zawislak, San Francisco, CA (US); Nathan Lucash, San Francisco, CA (US); Sandra Tsui, San Francisco, CA (US); Leslie Chiang, Santa Clara, CA (US)

(73) Assignee: Google Inc., Mountain View, CA (US)

(21) Appl. No.: 11/939,786

(22) Filed: Nov. 14, 2007

(51) Int. Cl. G06Q 30/00; G06Q 10/00

(52) U.S. Cl. CPC G06Q 30/0275; G06Q 30/0244

(57) ABSTRACT

General instructions for formatting advertisements are identified, content for a specific advertisement is identified, and the specific advertisement is displayed on a medium according to the identified formatting instructions. In connection with offering to publish advertisements, a CSS file is identified to be used to format the advertisements.

### TECHNICAL FIELD

This disclosure relates to information management.

### BACKGROUND

Web pages on the Internet frequently include advertisements. In some cases, stylistic elements of the advertisements, such as font faces, sizes, and colors, are specified when the ad is requested from an ad server. Custom settings for a given web page publisher may be stored at the ad server and applied to ads for that publisher automatically.

Cascading Style Sheets (CSS) is a mechanism for adding stylistic elements to web documents. CSS files associated with web pages include formatting definitions that can be applied to the content of the web pages by reference, without the web pages including specific formatting details themselves. Different CSS pages can be used to display a common web page in different styles, in different formats, or on different devices, to name a few examples.

### SUMMARY

In general, in one aspect, general instructions for formatting advertisements are identified, content for a specific advertisement is identified; and the identified content is displayed on a medium according to the identified formatting instructions.

Implementations may include none, one or more of the following features. The formatting instructions can include a CSS file. The formatting instructions can include instructions to apply a CSS file. The medium can include one or more of a web page, a video, or a printed document. The formatting instructions and the content can each be received from a different source. Obtaining the set of instructions can include retrieving the instructions from a location specified by a source of the instructions. Obtaining the set of instructions can include retrieving the instructions from a location identified by a source of the web page. The formatting instructions can be received from a source of the medium. Receiving the instructions can include identifying the source of the medium, determining that the source of the web page has identified a set of instructions for formatting advertisements, and obtaining the set of instructions identified by the source of the medium. The formatting instructions can be associated with a user. Receiving the instructions can include identifying the user, determining that the user has identified a set of instructions for formatting advertisements, and obtaining the set of instructions identified by the user. The formatting instructions can be associated with a source of the advertisement. Receiving the instructions can include identifying an advertiser associated with the specific advertisement, determining that the advertiser has identified a set of instructions for formatting advertisements, and obtaining the set of instructions identified by the advertiser.

In general, in another aspect, in connection with offering to publish advertisements, a CSS file is identified to be used to format advertisements.

Implementations may include one of more of the following features. Identifying the CSS file can include providing a copy of the CSS file. Identifying the CSS file can include providing a location of the CSS file. Identifying the CSS file can include identifying a specific CSS file associated with a user. An advertisement to publish can be received, formatted according to the identified CSS file, and published. An advertisement to publish can be received and published with the identified CSS file. A first price can be identified at which the identified CSS file will be used to format the advertisements, and a second price can be identified at which a CSS file other than the identified CSS file will be used to format the advertisements. An advertisement to publish and a CSS file other than the identified CSS file can be received, and the advertisement can be formatted according to the received CSS file and published.

These and other aspects and features, and combinations of them, may be expressed as methods, apparatus, systems, means for performing functions, program products, and in other ways. Other features and advantages of the invention will be apparent from the description and the claims.

### DESCRIPTION OF DRAWINGS

FIG. 1 shows an example of a system for delivering advertisements to web browsers.

FIG. 2 is a data flow diagram showing an example data flow in a process for controlling the appearance of advertisements using cascading style sheets (CSS).

FIG. 3A shows an example process by which a publisher of a web site may control the appearance of an advertisement.

FIG. 3B shows an example process by which an advertiser may control the appearance of an advertisement.

FIG. 3C shows an example process by which a user may control the appearance of advertisements.

FIG. 4 shows a schematic diagram of a generic computer system.

### DETAILED DESCRIPTION

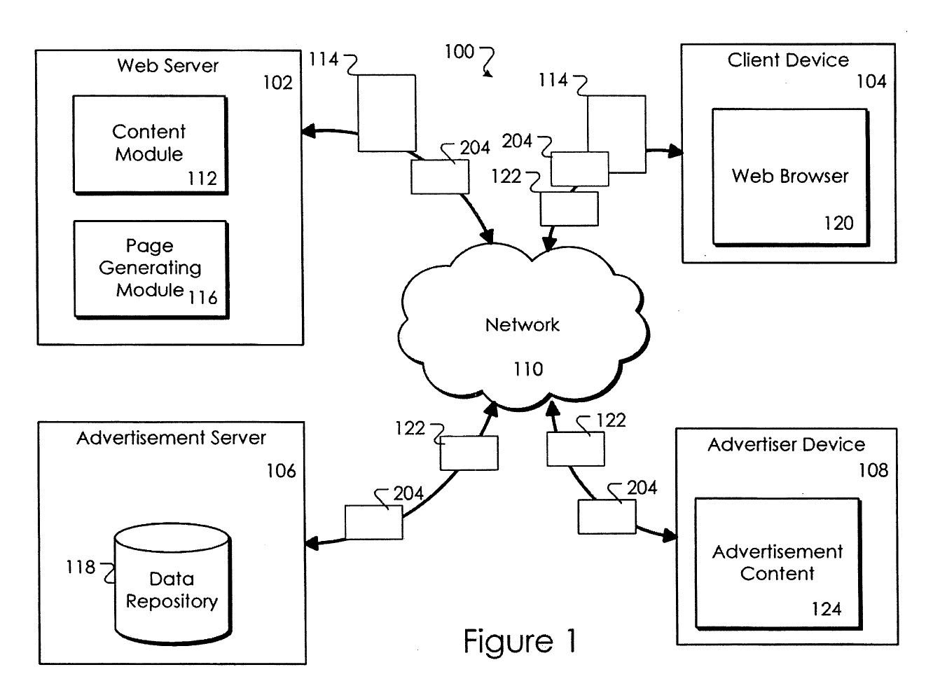

FIG. 1 shows an example of a system 100 for delivering advertisements (“ads”) to web browsers. Though reference is made to delivery of advertisements, system 100 can deliver other forms of content including other forms of sponsored content. The system 100 includes a web server 102, a client device 104, an advertisement server 106, an advertiser device 108, and a network 110. In some examples, the web server 102 provides web pages to the client device 104, in which the web pages include ads provided by the ad server 106. The web server 102, client device 104, and the ad server 106 are configured to enable control of the appearance of the advertisements by, for example, authors or publishers of the web pages, advertisers who own the ads, or users who view the ads. The appearances of the ads maybe controlled by using, for example, CSS files. Though reference is made to the control of the appearance of advertisements in web pages, system 100 can be used to control the appearance of other content in other forms of media (e.g., a print advertisement in a printed publication, a video advertisement in a multimedia presentation, etc.).

In the example of FIG. 1, the web server 102 contains a content module 112 and a web page generating module 116. The content module 112 provides the content of a web page 114 to be displayed. The content of the web page 114 can contain a forum thread, a conversation, a discussion, a news article, or some other content, to name just a few examples. The page generating module 116 creates the web page 114 containing the content provided by the content module 112. The page generating module 116 can also request advertisements 122 from the advertisement server 106 to be displayed on the web page 114. In some examples, the advertisements 122 are sent from the advertisement server 106 to the web server 102 and then forwarded to the client device 104. The advertisements 122 can be sent to the client device 104 already integrated into a web page 114 or they can be sent independently. In some examples, the advertisements 122 are sent directly to the client device 104 from the advertisement server 106.

The advertisements 122 are derived from advertisement content 124 (e.g., created by an advertiser) and are provided to the advertisement server 106 by the advertiser device 108. Alternatively, the system 100 or a third party can provide the advertisement content 124. The advertisements 122 may be stored in a data repository 118 at the advertisement server 106 or they may be provided on-demand directly from the advertiser device 108, which may itself be an advertisement server. In some examples, the advertisements 122 are generated on-demand by the advertisement server based on general instructions rather than specific content provided by the advertiser. For example, an advertisement may be generated directing a user to a current auction listing for a product a user entered as input in a search engine.

The client device 104 includes a web browser program 120. The web browser 120 can, among other things, display the web page 114 retrieved from the web server 102 through the network 110. The web page 114 can be requested by the user device 104 or the web server 102 may provide it without a request from the user device 104. The web browser 120 may also display the advertisements 122 if they are delivered without having first been integrated into the web page 114. In some examples, the web browser 120 may integrate the advertisements 122 into the web page 114 itself. Alternatively, or in addition, the web browser 120 may display the advertisements separately from the web page 114.

The web server 102, client device 104, advertisement server 106, and advertiser server 108, in the example of FIG. 1, are connected to each other by the network 110. The network 110 can, for example, be a local area network (LAN), a wide area network (WAN), the Internet, any other type of network, or any combination of types of networks. In some examples, one or more of the servers 102 and 106 and devices 104 and 108 may be integrated, for example, the advertisement server 106 and the web server 102 may be integrated into a single server, or the advertiser server 106 and the advertiser device 108 may be integrated into a single device.

When advertisements are presented on web pages, one or more parties may desire to control the appearance of the advertisements.

The parties who may desire to control the appearance of advertisements include the author or publisher of the web page on which they appear, the advertiser, and the user who is ultimately viewing the ads. The author or publisher may want to assure that advertisements placed on his web page are consistent in appearance with the content of the page—this may include selecting a font face, text size and color, and background images and colors that match or complement those of the web page. The advertiser may want to assure that the appearance of the advertisement is consistent with their brand identity, for example, Coca-Cola may want an advertisement for Coke® to have white text on a red background using the same font as is used on their cans and bottles. A user may want to configure ads to use a combination of font size and color other than the default, for example, larger fonts in a high-contrast color scheme to accommodate limited vision.

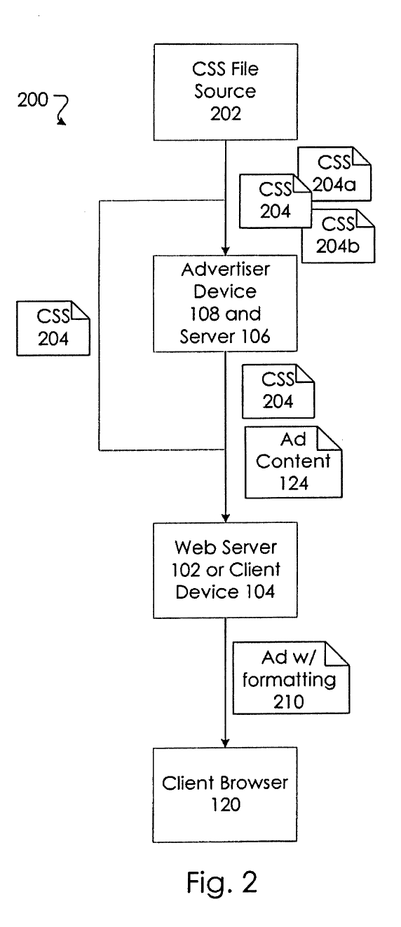

FIG. 2 is a data flow diagram showing an example of data flows 200 in a process for controlling the appearance of advertisements using cascading style sheets (CSS). CSS files 204 provide the interested parties with the ability to control the formatting of advertisements 122. CSS files 204 are stored in a CSS file source 202 from which they are available to advertisers, web site operators, and end users. The file source may be, in some examples, the data repository 118 (FIG. 1) or any other file storage location accessible to the advertisers, web site operators, or end users. Ads are created, for example, at the advertiser device 108 such that their content 124 will be formatted according to CSS files 204. In some examples, an advertiser may provide multiple CSS files 204a and 204b. The CSS files 204 may be stored at the advertisement server 106 (which may be integrated with the advertiser device 108) or at other servers (not shown). When the web an advertisement is requested, for example, by the server 102 or the client device 104, both the advertising content 124 and the CSS file 204 are supplied. One or both of the web server 102 and the client device 104 use the CSS file to format the advertisement content 124 and deliver the formatted ad 210 to the client browser 120. The appropriate CSS file 204 can be supplied directly to the web server 102 or client device 104, independently of the advertisement content 124, or it may be supplied to the advertiser's system 106/108 and from there to the web server 102 or client device 104, according to the needs of one or more of the interested parties. This avoids the need for individual ads 122 (FIG. 1) to include formatting instructions or for specific formatting requests to be made each time an ad is requested for a given web page. This basic data flow pattern 200 can be adapted in various ways to accommodate different sources of the CSS file 204 or other ways of formatting the advertisements.

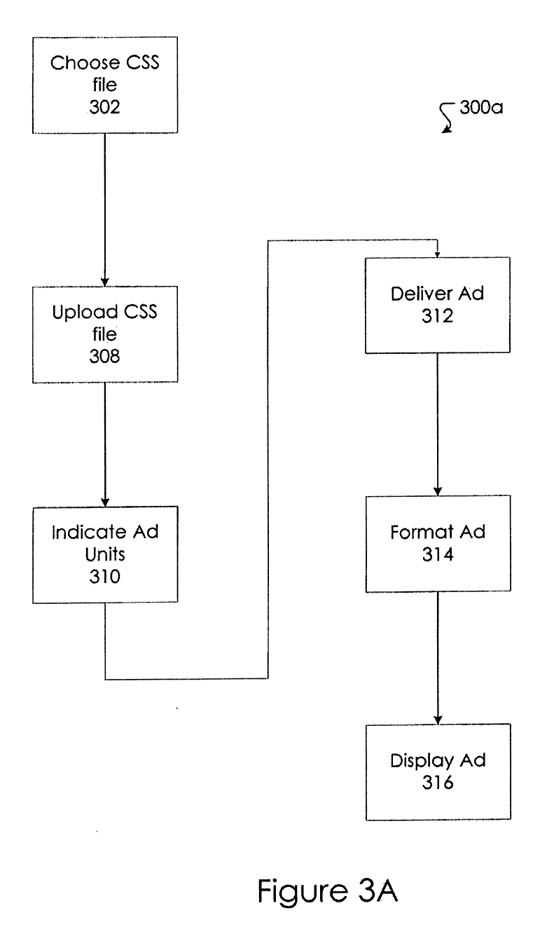

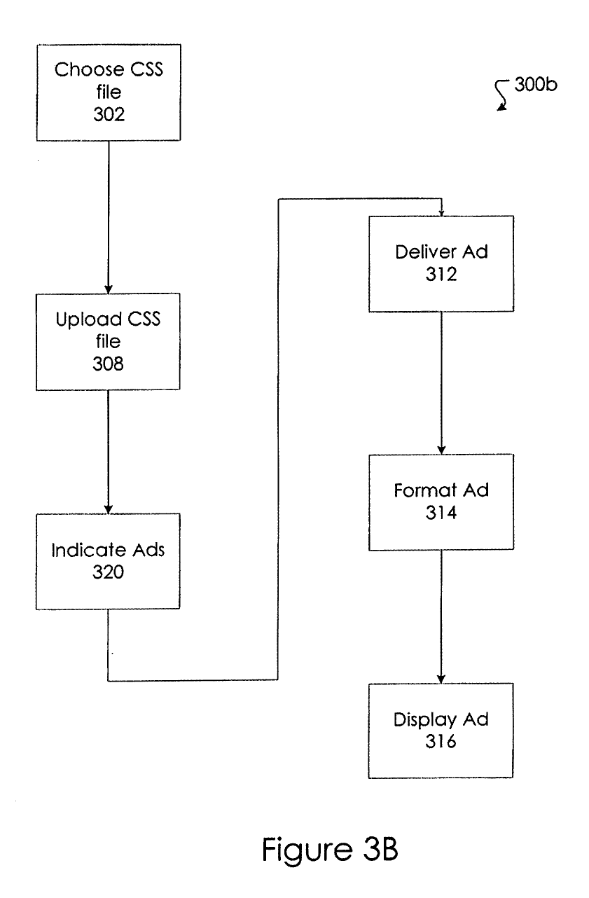

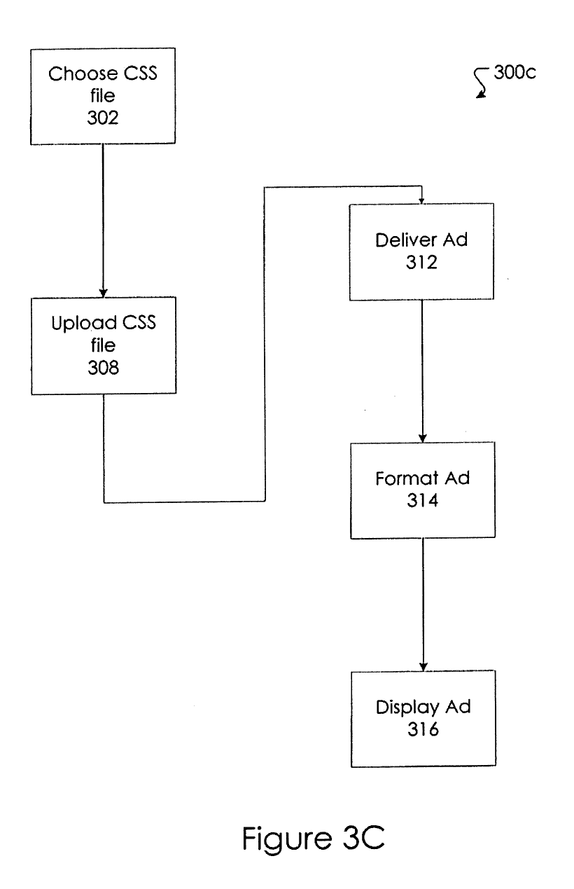

FIG. 3A shows an example of a process 300a by which a publisher of a web site may control the appearance of an advertisement. In this example, the CSS file 204 (FIG. 2) is chosen 302 by the publisher of the web site from the CSS files available from the CSS file source 202 (which may be the publisher's own server). The publisher may create the CSS file himself or he may obtain it from some third-party source (e.g., a fan of the website or a professional graphic artist). If the publisher created the CSS file 204, he may upload 308 to a server to share with others, for example, he may upload the CSS file 204 to the advertisement server 106. The publisher next indicates 310 which ad units on his web site the CSS file 204 should be applied to. Whenever the advertisement server 106 (FIG. 1) delivers 312 ad content 124 for use in the specified ad unit (for example, to the web server 102 or directly to the client device 104), the ad 122 is formatted 314 according to the formatting instructions in the chosen CSS file 204. The formatted ad 210 is then displayed 316 by the web browser 120.

If the web server 102 has direct access to the CSS file, it may perform the formatting 314 itself, and the steps of uploading 308 the CSS file 204 and specifying 310 its use may be skipped (or effectively performed internally). Uploading 308 the CSS file 204 may also be skipped if the CSS file 204 is already stored at the advertisement server 106, for example, if it was supplied by the advertiser. Depending on the implementation, various steps of the process 300 may be performed in a different order or combined into single actions.

In some examples, the publisher may store the CSS file locally, e.g., on the web server 102 with the content of the web page, and specify where the CSS file may be found when indicating 310 which ad units to use it with. This may be done, for example, by transmitting a URL of the CSS file to the advertisement server 106, putting the URL in an agreed-upon location, such as in a text file similar to the robots.txt file used by web sites to control search engine indexing, or by putting the CSS file itself in an agreed-upon location. In another variation, the publisher may apply the formatting dictated by the CSS file itself after text or HTML representing the ad is sent from the ad vendor to the publisher.

FIG. 3B shows an example of a process 300b by which an advertiser may control the appearance of an advertisement. In this example, the CSS file 204 is chosen 302 by the advertiser. The advertiser creates or obtains the CSS file 204 and uploads it 308, for example, to the advertisement server 106. The advertiser may indicate 320 which of the advertiser's ads the CSS file 204 should be used with, for example, by specifying specific ads, specific ad units, or one or more properties, such as key words, that would cause an ad to be delivered. For example, a retail store might provide a CSS file 204a that provides an elegant style to an advertisement, and specify that that CSS file 204a should be used to format ads delivered to upscale web sites and any ads generated based on key words associated with luxury products that they sell, while another CSS file 204b that provides a different style is used for ads delivered to children's web sites.

To deliver the formatted advertisement, the advertisement server 106 (FIG. 1) may apply the CSS file 204 and deliver 312 a formatted ad 210 or it may deliver 312 the CSS file 204 together with the unformatted advertisement content 124. The server 106 may provide the CSS file 204 by directly sending the file or by indicating its location on a server available to the web server 102 or to the client device 104. The CSS file 204 may be provided to the web server 102 to apply to the advertisement content 124 before transmitting the HTML describing the web page 114 to the viewer, or it may be provided directly to the user's web browser to be applied when the page is rendered.

FIG. 3C shows an example of a process 300c by which a user may control the appearance of advertisements. In this example, the CSS file 204 is chosen 302 by the viewer of the web page. If the viewer has an account with the ad vendor, he may upload 308 the CSS file 204 to the advertisement server 106 or another server maintained by the ad vendor where information pertinent to the viewer's account is maintained. When the advertisement server 106 delivers 312 an ad to that viewer, it may apply the viewer's chosen CSS file 204 and deliver a formatted ad 210 (FIG. 2) or it may deliver 312 the ad content 124 and CSS file 204 for handling by the web browser 120. Similarly to the process 300a in FIG. 3A, the viewer may also specify a location of the CSS file 204 or place it in a given location so that the advertisement server 106 can find it, or the viewer may configure his browser 120 to apply the CSS file 204 whenever an ad is placed on a web page 114.

If more than one of the above examples are implemented, such that more than one party may attempt to control the appearance of advertisements, various policies may be implemented to determine which party's preferences control. For example, an advertiser may be given priority over a user's selection in order to maintain the consistency of the advertiser's branding. To implement the above examples, advertisements are configured to make use of the CSS files and to respect the formatting they indicate. This can be accomplished by including HTML commands to use CSS formatting in the text defining the advertisement content 124. Other formatting systems can be used, such as Document Style Semantics and Specification Language (DSSSL), Extensible Stylesheet Language (XSL), other style sheet languages, and other standards for specifying formatting or a proprietary standard developed by the ad vendor or a third party.

The ability to style advertisements using CSS files represents an additional source of revenue to web sites beyond that brought in by advertisements alone. A web publisher may specify a minimum amount of compensation he would require to apply an advertiser-specified CSS file to advertisements his web page (e.g., a flat rate, a cost-per-thousand-impressions (CPM), or some other arrangement). Advertisers may specify specific web sites or types of websites on which they want to format the advertisements, which may be a narrower set than the websites on which they want their ads placed, and what price they will pay for their formatting to be used. Advertisers may bid on the right to have their formatting used when their ads are placed on a web page, as part of or in addition to the existing process by which they may bid or pay for placing the ads in the first place.

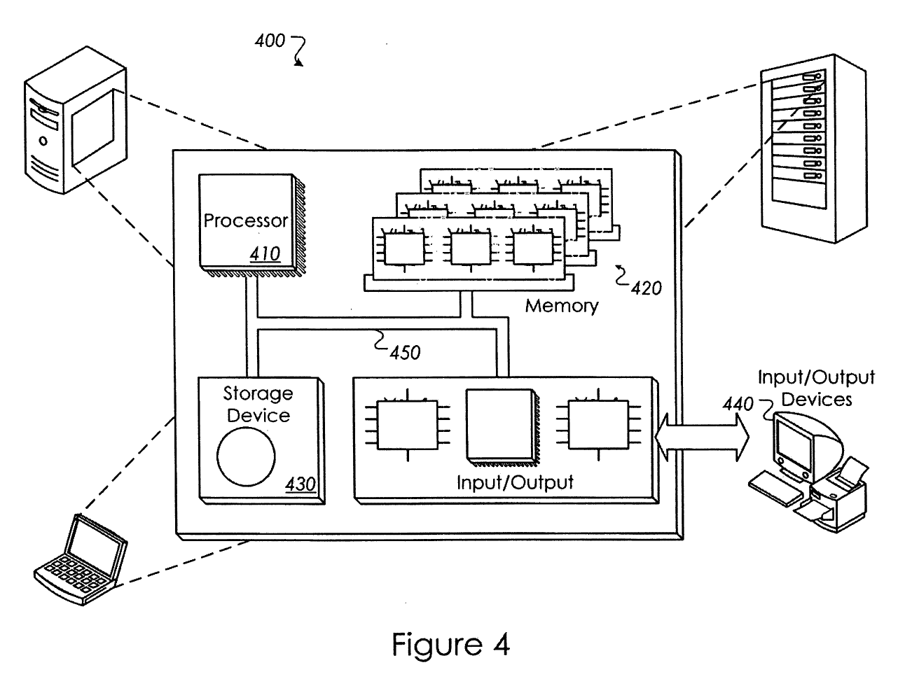

FIG. 4 is a schematic diagram of an example of a generic computer system 400 that can be used to implement, e.g., the web server 102, the client device 104, or the advertisement server 106. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The computing system 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document. The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A computer-implemented method for displaying advertisements, the method comprising:
identifying, by a computer, a first style sheet that specifies formatting instructions for formatting advertisements selected for presentation in an ad unit of a medium, the first style sheet being selected by a publisher of the medium;
selecting, by the computer and for presentation in the ad unit, content for a specific advertisement provided by an advertiser, the advertiser being an entity that is different from the publisher;
identifying, by the computer, a second style sheet that specifies formatting instructions for the specific advertisement, the second style sheet being selected by an advertiser that provided the specific advertisement;
determining, by the computer, whether a bid corresponding to the second style sheet is less than a minimum amount of compensation specified by the publisher for presenting an advertisement that is formatted in accordance with the second style sheet;
in response to determining that the bid is at least the minimum amount specified by the publisher, formatting, by the computer, the specific advertisement according to the second style sheet; and
in response to determining that the bid is less than the minimum amount specified by the publisher, formatting, by the computer, the specific advertisement according to the first style sheet provided by the publisher.

2. The method of claim 1 in which the formatting instructions comprise a Cascading Style Sheet file.

3. The method of claim 1 in which the formatting instructions comprise instructions to apply a Cascading Style Sheet file.

4. The method of claim 1 in which the medium comprises one or more of a web page, a video, or a printed document.

5. The method of claim 1 in which the second style sheet and the content are each received from a different source.

6. The method of claim 1 also comprising retrieving the first style sheet from a location identified by a source of the instructions.

7. The method of claim 1 also comprising retrieving the first style sheet from a location identified by a source of the medium.

8. The method of claim 1 also comprising receiving the first style sheet from a source of the medium.

9. The method of claim 8 in which receiving the first style sheet comprises:
identifying the source of the medium;
determining that the source of the medium has identified the first style sheet as including a set of specific instructions for formatting advertisements; and
obtaining the first style sheet including the set of specific instructions identified by the source of the medium.

10. The method of claim 1 further comprising identifying a third style sheet specifying formatting instructions for formatting advertisements selected for presentation to a particular user, the third style sheet being selected by the particular user.

11. The method of claim 10 also comprising:
identifying the particular user;
determining that the particular user has identified the third style sheet as including a set of specific instructions for formatting advertisements; and
obtaining the third style sheet including the set of specific instructions identified by the particular user.

12-13. (canceled)

14. A computer program stored on a computer-readable medium and comprising instructions to cause a computer to:
identify a first style sheet that specifies formatting instructions for formatting advertisements selected for presentation in an ad unit of a medium, the first style sheet being selected by a publisher of the medium;
select content for a specific advertisement provided by an advertiser, the advertisement being selected for presentation in the ad unit, the advertiser being an entity that is different from the publisher;
identify a second style sheet that specifies formatting instructions for the specific advertisement, the second style sheet being selected by the advertiser that provided the specific advertisement;
determine whether a bid corresponding to the second style sheet is less than a minimum amount of compensation specified by the publisher for presenting an advertisement that is formatted in accordance with the second style sheet;
in response to a determination that the bid is at least the minimum amount specified by the publisher, format the specific advertisement according to the second style sheet; and
in response to a determination that the bid is less than the minimum amount specified by the publisher, format the specific advertisement according to the first style sheet provided by the publisher.

15. An apparatus comprising:
a storage device storing data representing a first style sheet that specifies instructions for formatting advertisements provided by advertisers and selected for presentation in an ad unit of a medium, the first style sheet being provided by a publisher of the medium, the storage device further storing data representing a second style sheet that specifies formatting instructions for a specific advertisement, the second style sheet being selected by an advertiser that provided the specific advertisement; and
at least one processor coupled to the storage device, the at least one processor configured to provide data that causes content of the specific advertisement to be provided for display in the ad unit of the medium and according to one of the first style sheet and the second style sheet, the content of the specific advertisement being displayed according to the second style sheet when a bid corresponding to the second style sheet is determined to be at least equal to a minimum amount specified by the publisher of the medium, the minimum amount being an amount requested by the publisher for presentation of the specific advertisement according to the second style sheet, and the content of the specific advertisement being displayed according to the first style sheet when the bid is determined to be less than the minimum amount.

16-25. (canceled)

26. The method of claim 1 in which the first style sheet is associated with particular ad units on the medium, and the method comprises applying the first style sheet to advertisements that are delivered at the particular ad units.

27. The method of claim 26 in which applying the comprises applying same formatting instructions to advertisements that are delivered at the particular ad units, in which at least two different advertisements are provided by different advertisers.

28. (canceled)

29. The method of claim 1 in which the first style sheet provided by the publisher is stored at an advertisement server.

30. The computer program of claim 14 in which the first style sheet comprises instructions stored in a Cascading Style Sheet file.

31. The computer program of claim 14 in which the medium comprises at least one of a web page, a video, or a printed document.

32. The apparatus of claim 15 in which the first style sheet comprises instructions stored in a Cascading Style Sheet file.

33. The apparatus of claim 15 in which the medium comprises at least one of a web page, a video, or a printed document.

34-41. (canceled)
